(19) United States
(12) Patent Application Publication
(10) Pub. No.: US 2017/0037681 A1
(43) Pub. Date: Feb. 9, 2017

(54) AESTHETICS ENHANCING VERTICAL BLIND COMBINATION DEVICE FOR WINDOWS

(71) Applicant: Rafael Zaldeti, Lauderhill, FL (US)

(72) Inventor: Rafael Zaldeti, Lauderhill, FL (US)

(21) Appl. No.: 14/820,886

(22) Filed: Aug. 7, 2015

(51) Int. Cl. E06B 9/386; E06B 9/36; E06B 9/24

(52) U.S. Cl. CPC E06B 9/386; E06B 9/24; E06B 9/36; E06B 2009/2429

(57) ABSTRACT

An aesthetics enhancing vertical blind combination device for windows includes a plurality of standard vertical blind panels and a plurality of decorative overlays.

### BACKGROUND OF THE DISCLOSURE

### Field of the Disclosure

The disclosure relates to vertical blind combination devices and more particularly pertains to a new vertical blind combination device for enhancing the aesthetics of windows.

### SUMMARY OF THE DISCLOSURE

An embodiment of the disclosure meets the needs presented above by generally comprising an aesthetics enhancing vertical blind combination device for windows. The device comprises a plurality of standard vertical blind panels and a plurality of decorative overlays.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an angled front view of an aesthetics enhancing vertical blind combination device for windows according to an embodiment of the disclosure.

FIG. 2 is a front view of an embodiment of the disclosure.

FIG. 3 is an in-use side view of an embodiment of the disclosure.

FIG. 4 is a detailed view of an embodiment of the disclosure.

FIG. 5 is an in-use side view of an embodiment of the disclosure.

### DESCRIPTION OF THE PREFERRED EMBODIMENT

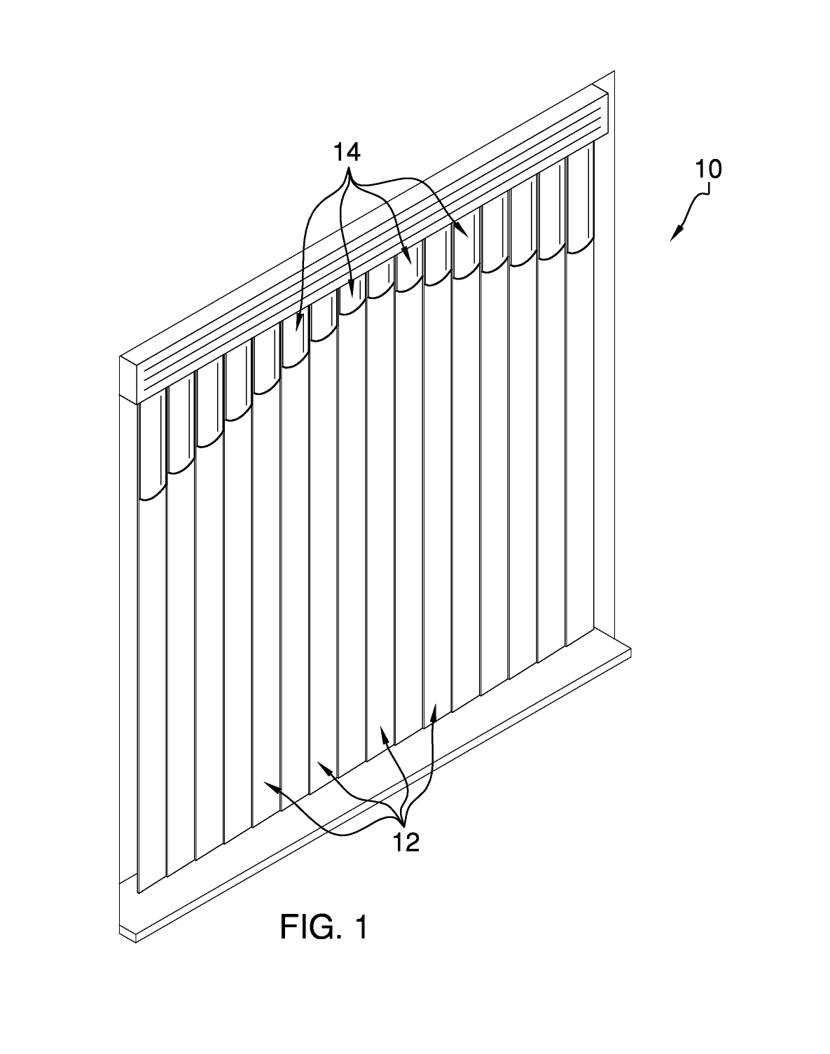

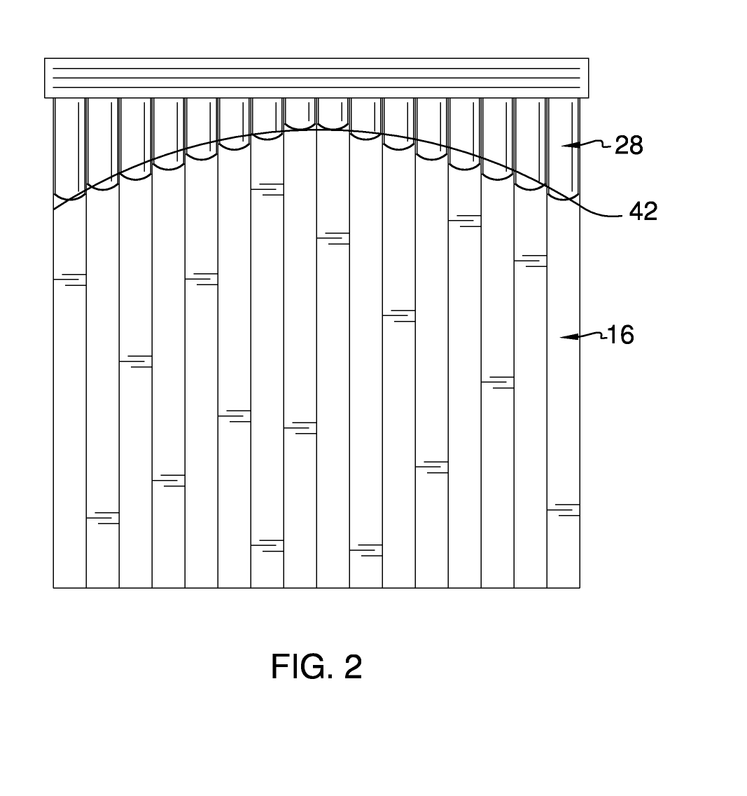

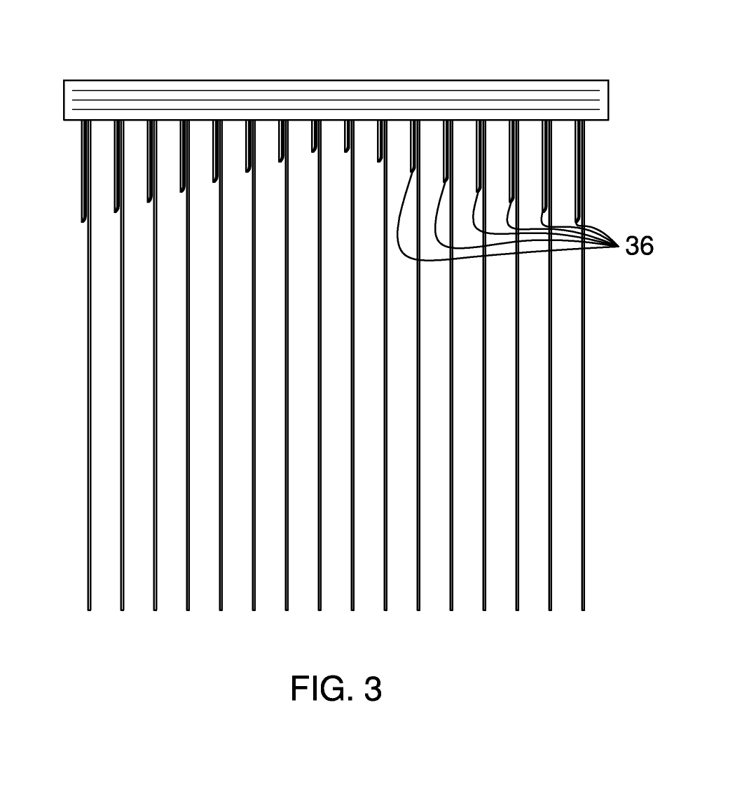

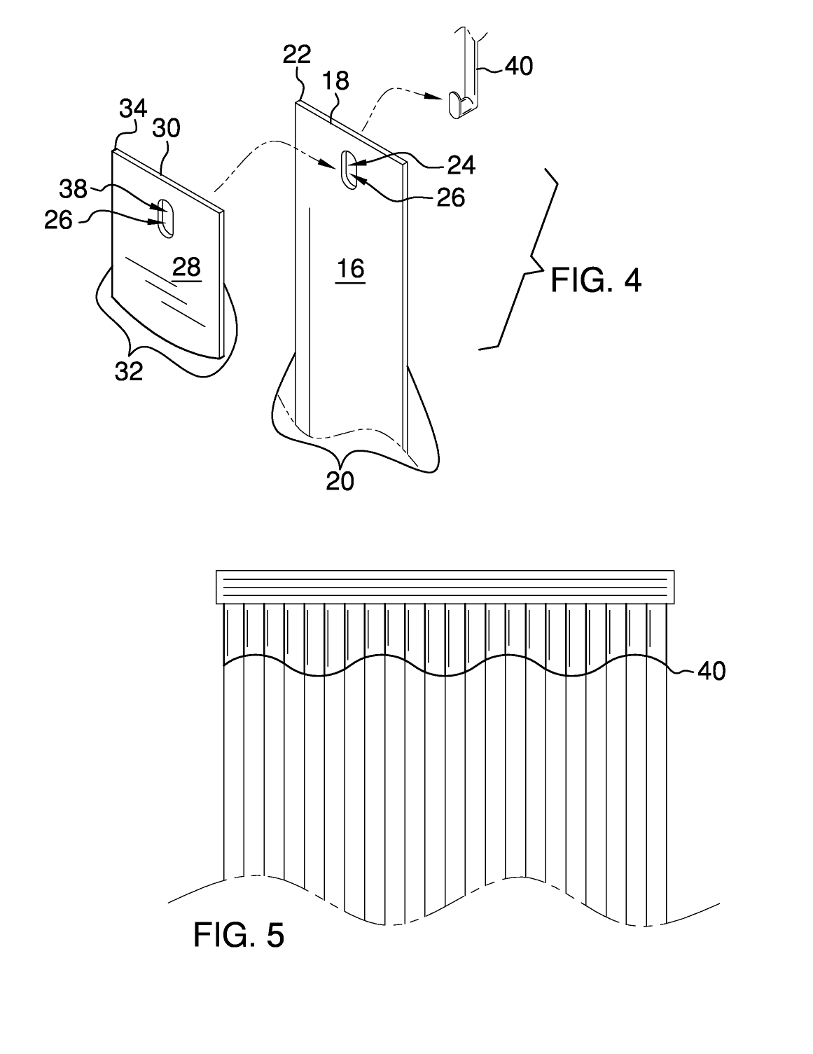

With reference now to the drawings, and in particular to FIGS. 1 through 5 thereof, a new vertical blind combination device embodying the principles and concepts of an embodiment of the disclosure and generally designated by the reference numeral 10 will be described.

As best illustrated in FIGS. 1 through 5, the aesthetics enhancing vertical blind combination device for windows 10 generally comprises a plurality of standard vertical blind panels 12 and a plurality of decorative overlays 14. Each of the standard vertical blind panels 16 has a top edge 18 having a length of between 4 and 20 centimeters, and a pair of opposing side edges 20 having equivalent lengths of between 30 and 400 centimeters. The opposing side edges 20 connect to an associated end 22 of the top edge 18 at a right angle. Extending through each standard vertical blind panel 16 is a slot 24 proximate to the top edge 18. The slot 24 is shaped as an elongated oval 26 and is positioned equally distant from the opposing side edges 20 of the standard vertical blind panel 16.

Each of the overlays 28 has an upper rim 30 with a length of between 4 and 20 centimeters, and a pair of opposing side rims 32 having a length of between 6 and 300 centimeters. The opposing side rims 32 connect to an associated terminus 34 of the upper rim 30 at a right angle. The opposing side rims 32 of an overlay 28 are of equivalent lengths, but opposing side rims 32 of the plurality of decorative overlays 14 may comprise a collection of lengths 36 from between 6 and 300 centimeters. Extending through each overlay 28 is an opening 38 proximate to the upper rim 30. The opening 38 is shaped as an elongated oval 26 and is positioned equally distant from the opposing side rims 32 of the overlay 28. The opening 38 is positioned such that the overlays 28 can be configured with the opening 38 aligning with the slot 24 of the standard vertical blind panel 16, such that the pair can engage the vertical blind hanging apparatus 40.

In use, a plurality of decorative overlays 14 is paired with an equally numbered plurality of standard vertical blind panels 12, such that each standard vertical blind panel 16 is configured with an overlay 28 and the opening 38 of the overlay 28 aligns with the slot 24 of the standard vertical blind panel 16. In this configuration, the standard vertical blind panel 16 and the overlay 28 can be engaged to the vertical blind hanging apparatus 40. As the opposing side rims 32 of the plurality of decorative overlays 14 may comprise a collection of lengths 36 from between 6 and 300 centimeters, it is possible arrange the plurality of decorative overlays 14 to form a variety of patterns, such as convex, concave 42, or wavy 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An aesthetics enhancing vertical blind combination device for windows, said device comprising:
a plurality of standard vertical blind panels; and
a plurality of decorative overlays.

2. The device of claim 1, further comprising:
each of said standard vertical blind panels having a top edge, said top edge having a length of between 4 and 20 centimeters,
each of said standard vertical blind panels having a pair of opposing side edges, said opposing side edges having a length of between 30 and 400 centimeters,
each of said standard vertical blind panels having a slot, said slot extending through said standard vertical blind panel proximate to said top edge; and
each of said overlays having an upper rim, said upper rim having a length of between 4 and 20 centimeters,
each of said overlays having a pair of opposing side rims, said opposing side rims having a length of between 6 and 300 centimeters; and
each of said overlays having an opening, said opening extending through said overlay proximate to said upper rim.

3. The device of claim 2, further comprising:
each of said standard vertical blind panels having said opposing side edges being of equivalent lengths, said opposing side edges connecting to an associated end of said top edge at a right angle,
each of said standard vertical blind panels having said slot being shaped as an elongated oval, said slot being positioned equally distant from said opposing side edges of said standard vertical blind panel,
each of said overlays having said opposing side rims connecting to an associated terminus of said upper rim at a right angle, said opposing side rims being of equivalent lengths; and
each of said overlays having said opening being shaped as an elongated oval, said opening being positioned equally distant from said opposing side rims of said overlay.

4. The device of claim 3, further comprising:
each of said overlays having said opposing side rims of each overlay comprising a collection of lengths from between 6 and 300 centimeters; and
each of said overlays having said opening being positioned such that said overlay can be configured with said opening aligning with said slot of said standard vertical blind panel to engage the vertical blind hanging apparatus.

5. An aesthetics enhancing vertical blind combination device for windows, said device comprising:
a plurality of standard vertical blind panels, each of said standard vertical blind panels having a top edge, said top edge having a length of between 4 and 20 centimeters, each of said standard vertical blind panels having a pair of opposing side edges, said opposing side edges having a length of between 30 and 400 centimeters, said opposing side edges being of equivalent lengths, said opposing side edges connecting to an associated end of said top edge at a right angle, each of said standard vertical blind panels having a slot, said slot extending through said standard vertical blind panel proximate to said top edge, said slot being shaped as an elongated oval, said slot being positioned equally distant from said opposing side edges of said standard vertical blind panel; and
a plurality of decorative overlays, each of said overlays having an upper rim, said upper rim having a length of between 4 and 20 centimeters, each of said overlays having a pair of opposing side rims, said opposing side rims having a length of between 6 and 300 centimeters, said opposing side rims connecting to an associated terminus of said upper rim at a right angle, said opposing side rims being of equivalent lengths, said opposing side rims of each overly comprising a collection of lengths from between 6 and 300 centimeters, and each of said overlays having an opening, said opening extending through said overlay proximate to said upper rim, said opening being shaped as an elongated oval, said opening being positioned equally distant from said opposing side rims of said overlay, said opening being positioned such that said overlay can be configured with said opening aligning with said slot of said standard vertical blind panel to engage the vertical blind hanging apparatus.
